(19) United States
(12) Patent Application Publication
(10) Pub. No.: US 2007/0088238 A1
(43) Pub. Date: Apr. 19, 2007

(54) Inflatable massaging boots

(76) Inventor: Jimmy Tseng, Fairfax, VA (US)

Correspondence Address: Jimmy Tseng, 12643 Buckleys Gate Drive, Fairfax, VA, 22030, US

(21) Appl. No.: 11/249,828

(22) Filed: Oct. 14, 2005

(51) Int. Cl. A61H 9/00

(52) U.S. Cl. 601/152; 601/151; 601/148; 601/DIG. 20

(57) ABSTRACT

An inflatable massaging boots, comprising mainly an air bladder of a general shape of a boots; a housing outside of the air bladder; an air valve provided on the air bladder and the housing; an air pump; a plurality of massage balls; a bottom sheet for positioning the massage balls; and two elastic bands for positioning the bottom sheet; the inflatable massaging boots can be used on one leg at one time, or on two legs simultaneously.

### FIELD OF THE INVENTION

This invention relates to an inflatable massaging boots, in particular to an inflatable massaging boots that can be controlled by a user for inflation or deflation alternatively.

### BACKGROUND OF THE INVENTION

Conventionally, a massaging stick, chair, or bed is used to massage legs. The massaging is not conducted on the whole leg and foot. Also, the massaging chair or bed is relatively expensive and not easy to carry to different location.

### SUMMARY OF THE INVENTION

An objective of the present invention is to provide an inflatable massaging boots that can perform massaging to the whole leg and foot simultaneously, either one leg or two legs. Another objective of the present invention is to provide an inflatable massaging boots that can be carried easily to a different location, and relatively inexpensive.

### BRIEF DESCRIPTION OF THE DRAWINGS

FIG. 1 is a longitudinal sectional schematic view of one of the inflatable massaging boots of the present invention with a leg and foot inside;

FIG. 2 is schematic side view of one of the inflatable massaging boots of the present invention, showing the inflated state of the boots;

FIG. 3 is similar to FIG. 2, viewing from the other side;

FIG. 4 is a bottom view of FIG. 1;

FIG. 5 is a top view of the bottom portion of the inflatable massaging boots;

FIG. 6 is a perspective view of a pair of the inflatable massaging boots;

FIG. 7 is a perspective view showing how to use a pair of the inflatable massaging boots;

FIG. 8 is a partial view showing the relative position of a foot, a plurality of massage balls, and a bottom sheet;

FIG. 9 is similar to FIG. 7, showing how to use one inflatable massaging boot;

FIG. 10 is a perspective view showing the inflatable massaging boots with an inflation means(air pump);

FIG. 11 shows a perspective view of air pump used in the present invention;

FIG. 12 shows a perspective view of a portion of the air pump shown in FIG. 11;

FIG. 13 is a perspective view similar to FIG. 12, looking from a difference angle;

FIG. 14 is a top view of the parts shown in FIG. 12;

FIG. 15 is an exploded view of the parts shown in FIG. 12;

FIG. 16 is a longitudinal sectional view of the parts shown in FIG. 12;

FIG. 17 is a top view of the air pump, with a cover installed;

FIG. 18 is a bottom view of the air pump;

FIG. 19 is a schematic view depicting the hand and the air pump; and

FIG. 20 is a similar to FIG. 19, showing different angle.

### DETAILED DESCRIPTION OF THE INVENTION

The inflatable massaging boots of the present invention includes mainly an air bladder 1, a housing (shell) 5 outside of the air bladder 1, an air valve 2 provided on the air bladder 1 and the housing 5, a bottom sheet 8 on the inside of the bottom of the air bladder 1, and a plurality of massage balls 4.

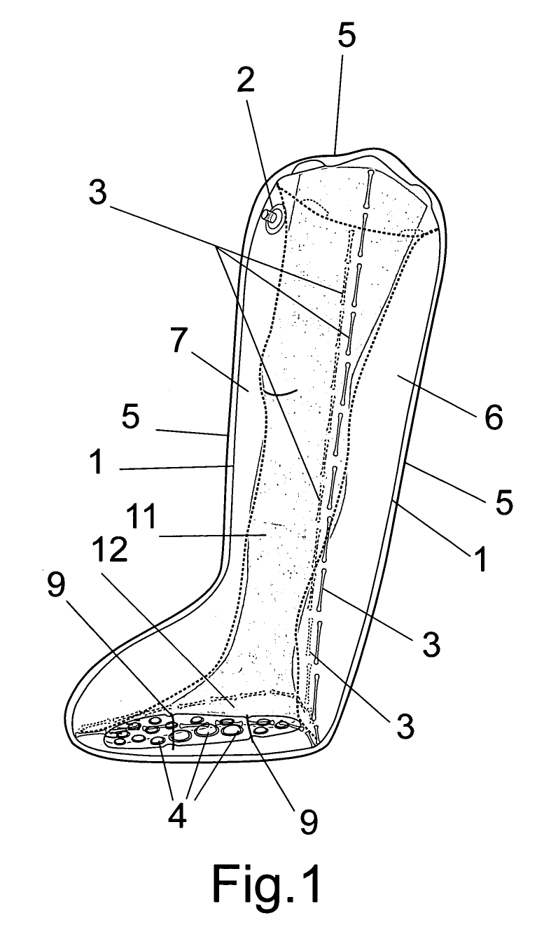

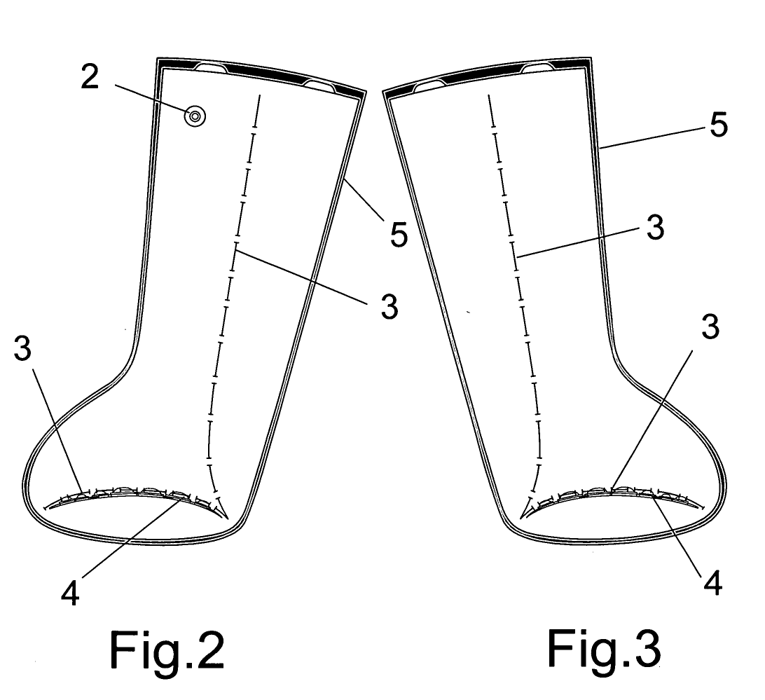

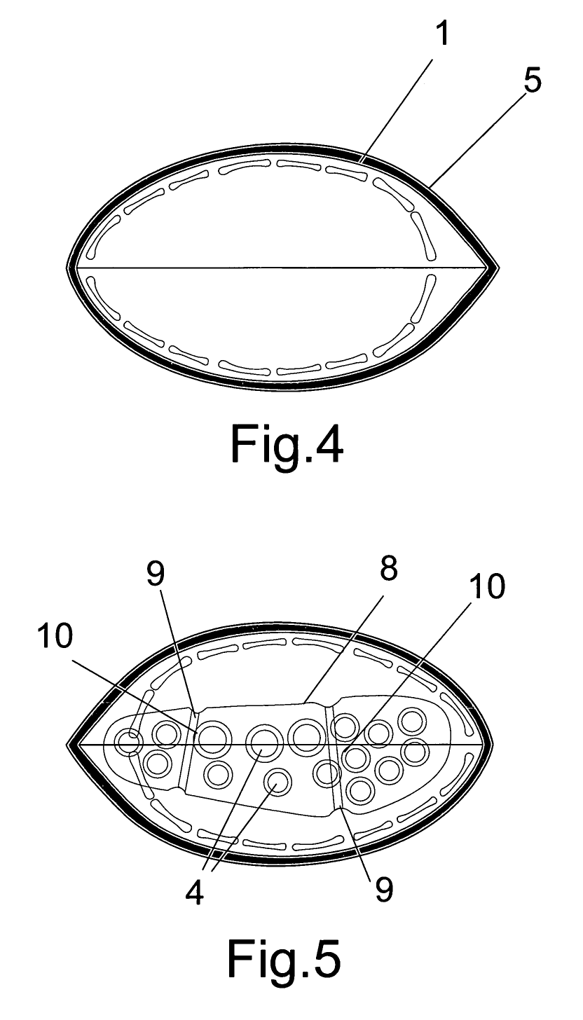

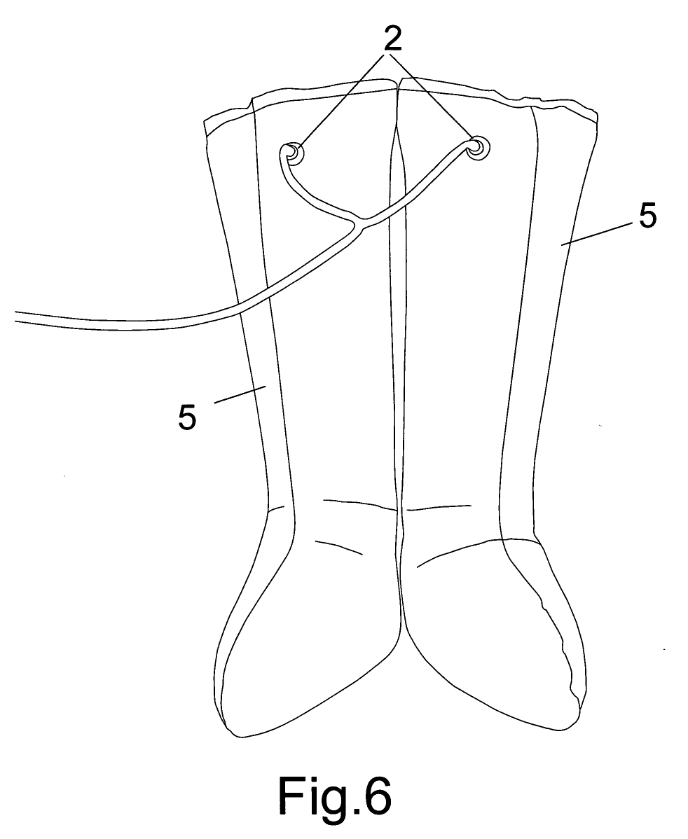

A plurality of welding lines 3 are provided in the air bladder 1 so as to divide the air bladder 1 into at least two air cells 6 and 7. The welding lines 3 are used to weld two adjacent sheets of the air bladder 1 and are in the form of broken lines, i.e. having sections welded and sections un-welded arranged alternatively, so that air can go through the welding lines 3. From FIG. 1, we can see the relative position of the leg 11, the foot 12, and the inflatable massaging boots. Deducted structure of the massage balls 4 and the bottom sheet 8 can be seen form FIG. 1 and 5. There are four cut-off portions 9 on the bottom sheet 8 for accommodating end portions of two elastic bands 10 which can be fixed to the air bladder 1, so that the bottom sheet 8 can be positioned therein. The massage balls 4 preferably art of the shape of semi-spherical.

The housing 5 can be made of soft fabric or other suitable material. The air bladder 1 can be made of PVC (poly vinyl chloride), TPU (thermoplastic polyurethane), PU (poly urethane), or other suitable material.

When the inflatable massaging boots is fully inflated, it can provide massage to the whole leg and foot accommodated in the boots. At this time, the massaging effects can be enhanced if the user moves user's foot 12 relative to the leg 11 in an up-and-down, left-and- right, and/or circular direction.

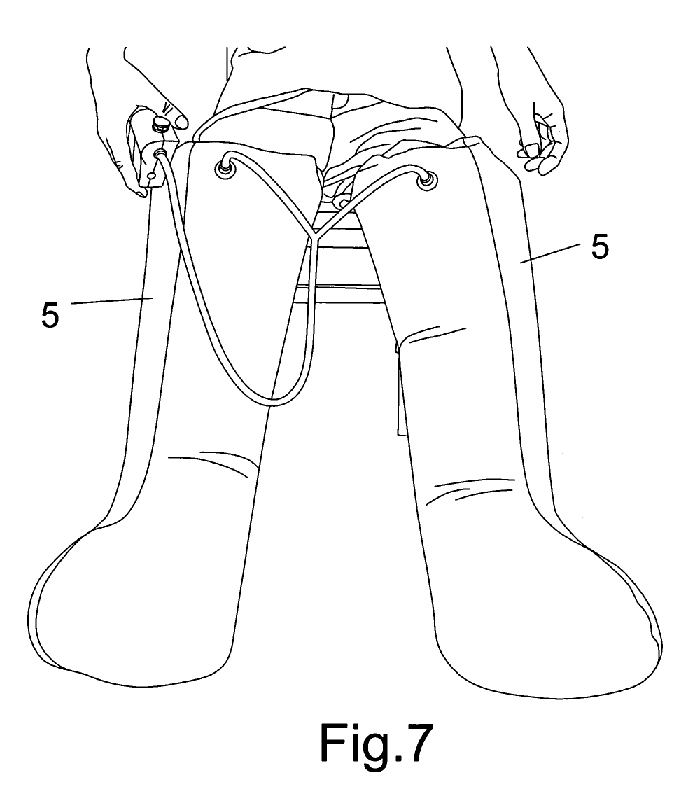

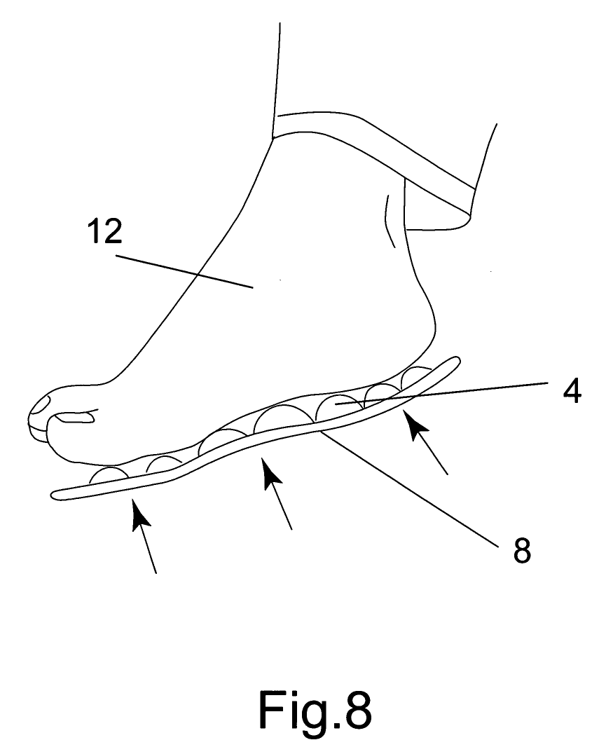

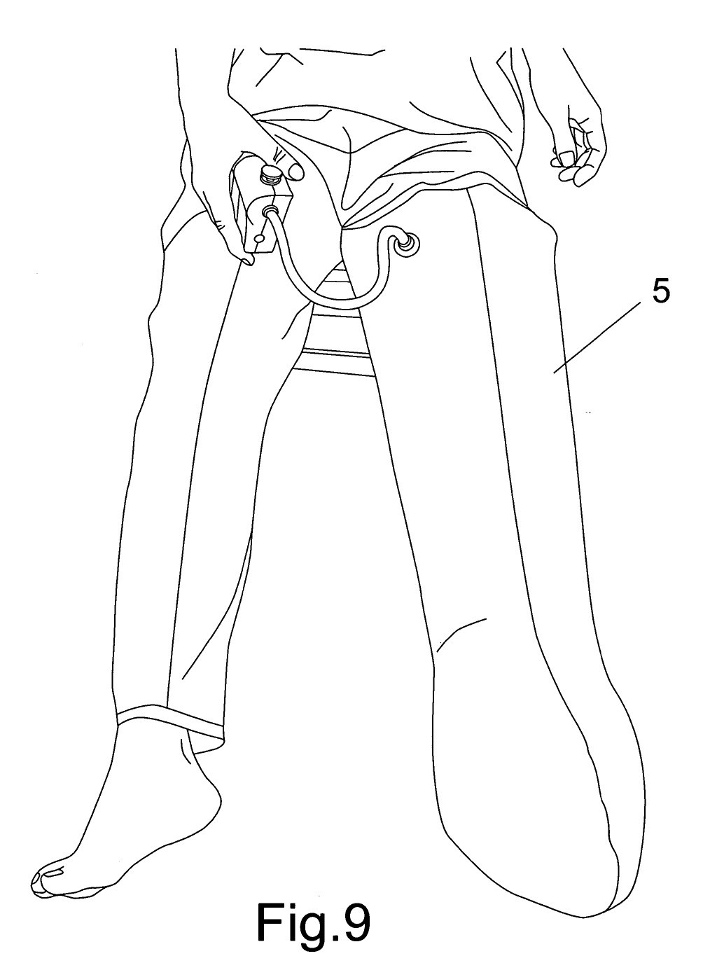

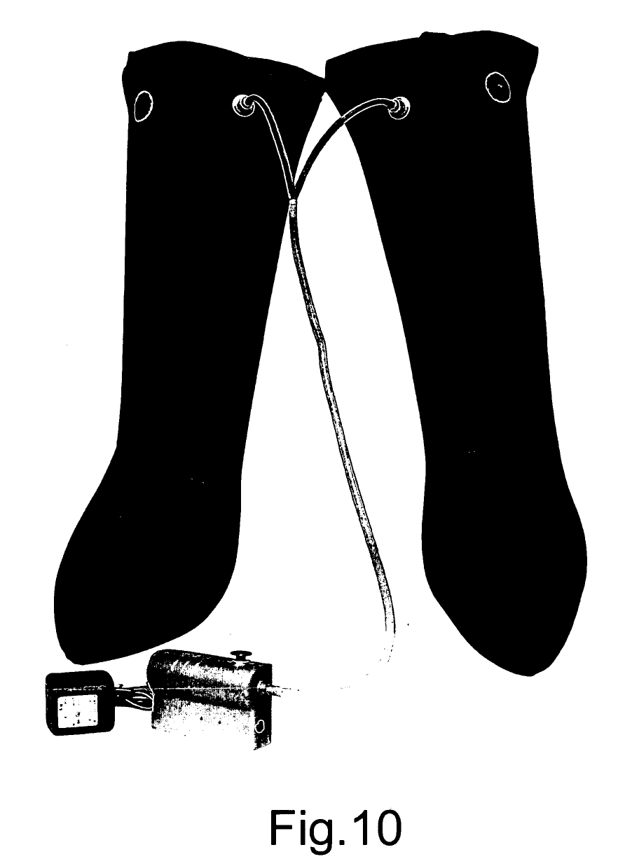

The inflatable massaging boots can be applied to both legs (FIG. 7) or just one leg (FIG. 9).

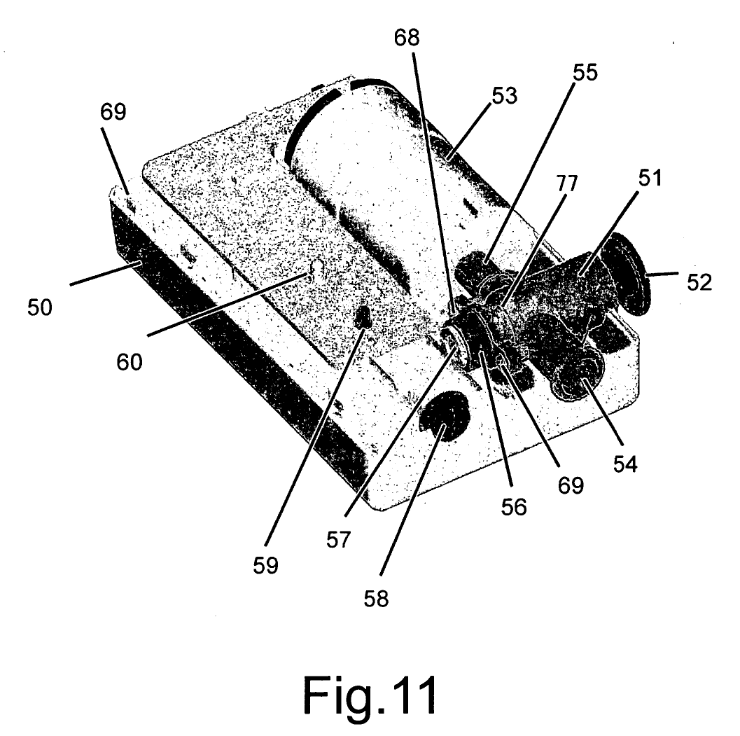

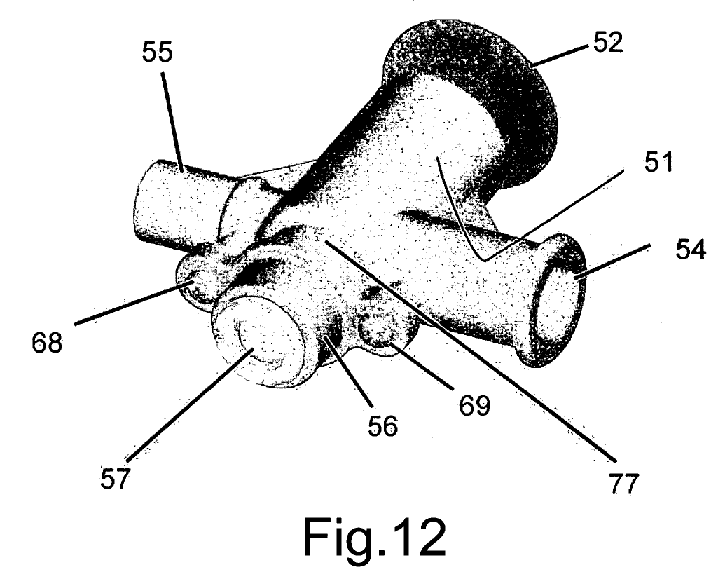

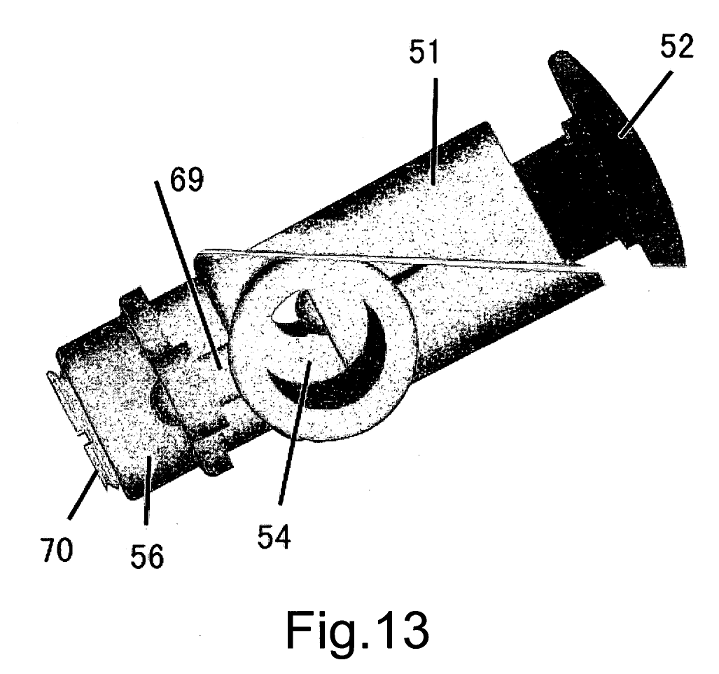

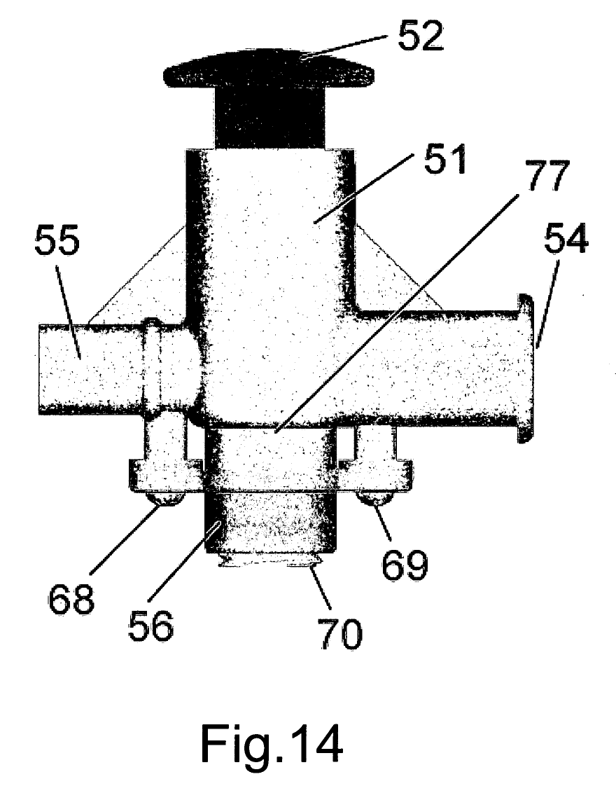

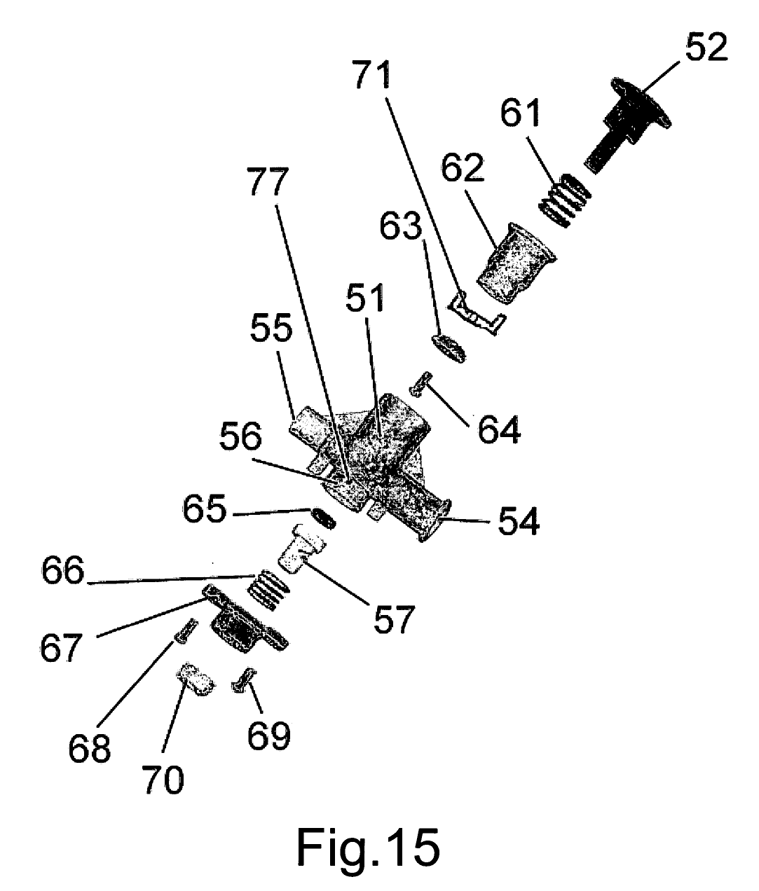

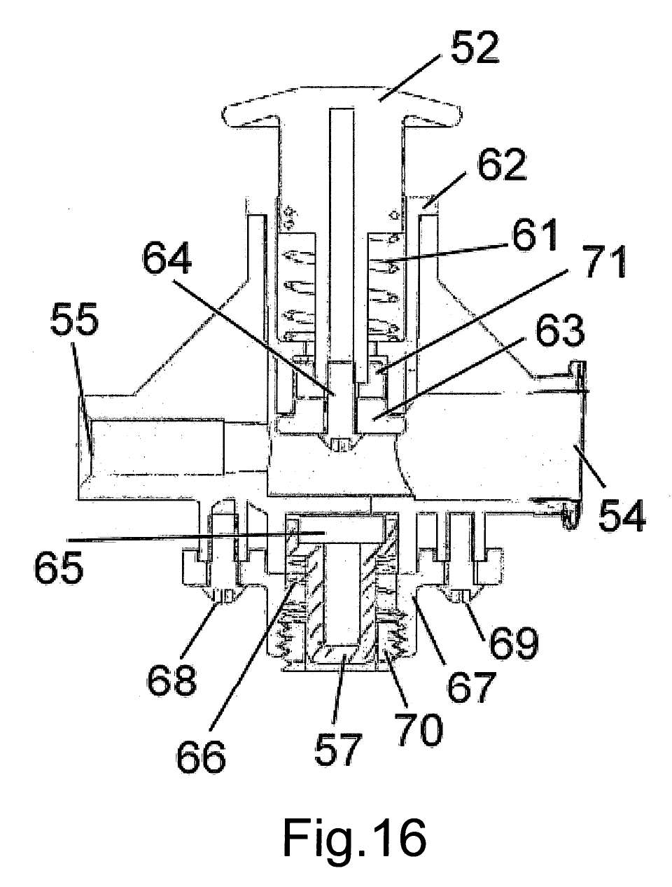

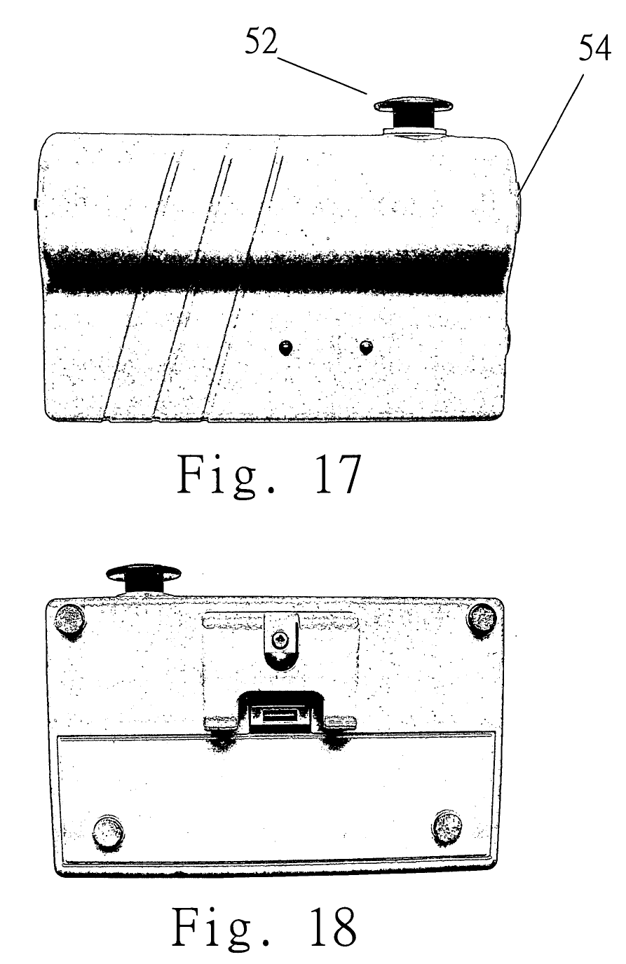

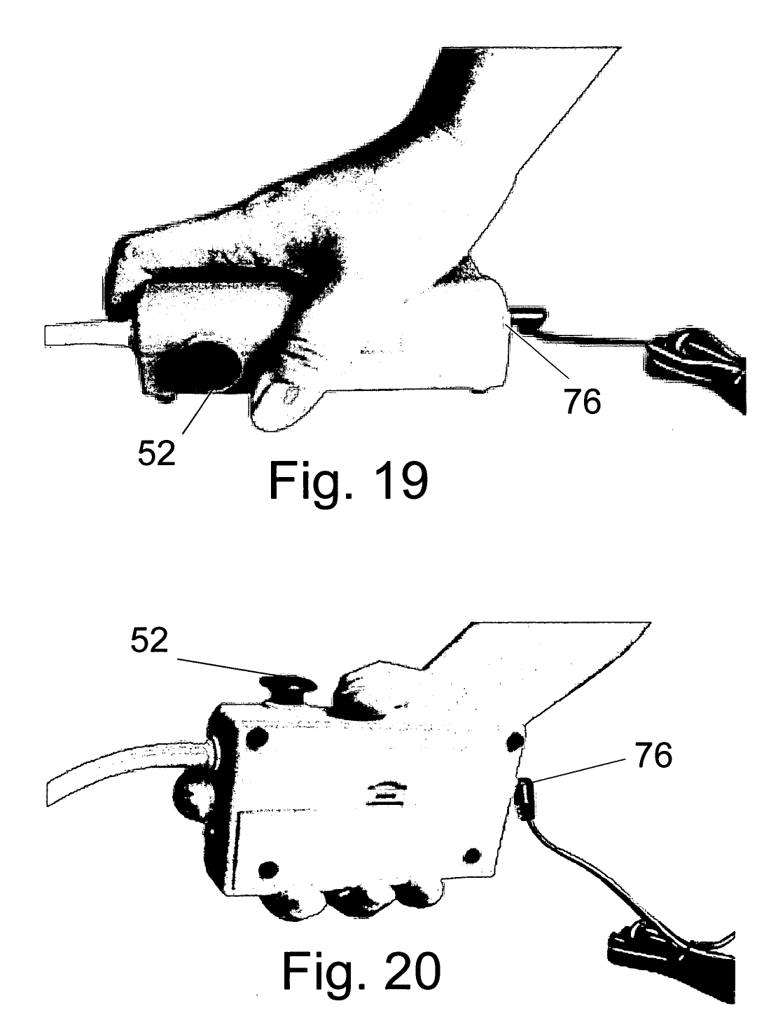

Please see FIGS. 11-16 for the detailed structure of the air pump 50. The air pump 50 comprises mainly a discharge valve button 52, a safety valve plunger 57, a pipe 51 for accommodating the discharge valve button 52 and relevant parts, a second pipe 56 for accommodating the safety valve plunger 57 and relevant parts, a pumping device 53, a pipe 55 in communicating with the pumping device 53, a pipe 54 for accommodating an end of an air tube having another end connected to the air valve of the inflatable massaging device of the present invention, and a starting button 58.

The discharge valve has the button 52, a spring 61, a socket 62, a fixation element 71, a piston 63, and a bolt 64 for fastening the button 52, the fixation element 71, and the piston 63 together. When the button 52 is pushed down, the piston 63, the fixation member 71 and the bolt 64 are pushed down simultaneously, and air can be discharged from an air release hole 77.

The safety valve has the plunger 57, a piston 65, a spring 66, a stopper 67, a micro-adjustment member 70, and two bolts 68 and 69 for fastening the stopper 67 to the pipes 54 and 55. The micro-adjustment member 70 and the stopper 67 have corresponding threads so that the member 70 can be rotated to adjust and set safety pressure which is preferably 0.015 MPA (mega Pascal). When the air pressure in the air tube or pipe 54 is more than the set value, the plunger 57 and the piston 65 is pushed downward by the air pressure and excessive air can be discharged from the air release hole 77.

Indicating light 59 indicates the inflation of the air pump 50, indicating light 60 indicates that the power is “on”, A switch 72 is provided on the housing of the air pump 50, A socket 73 is also provided on the housing of the air pump 50 for the insertion of a plug (line) 76 of an adapter (ac/dc converter), A clip (or hook) 74 is provided on the housing of the air pump 50 for attaching the air pump 50 on a belt or pocket of the user. A battery compartment 75 is also provided on the housing for accommodating batteries.

When the user's hand (finger, preferably forefinger) pushes down the starting button 58, the pumping device 53 is energized to provide air to the air valve on the inflatable massaging device of the present invention through the pipes 53 and 54, and an air tube (not shown in the drawings), and thus the inflatable massaging device is inflated when the user's hand (finger, preferably thumb) pushes down the safety valve plunger 57, air from the inflatable massaging device is discharged at air release hole 77 through the air valve, air tube, and the pipe 54, and thus the inflatable massaging device can be deflated.

In actual use, the user can choose one of the following three ways, or other suitable ways;

(1) Push and release: the user continuously inflate the inflatable massaging device until the user can not tolerate, then deflate the same, then inflate and deflate it alternatively;

(2) Continuous inflation: the user inflate the inflatable massaging device fully, then discharge about half of the air in that device, and then inflate it fully again. These steps can be repeatedly done.

(3) Full inflation and full release: the user inflate the inflatable massaging device fully, then turn off the air pump 50, let the air stay in the inflatable massaging device for a while (eg. 3-5 minutes), then deflate the inflatable massage device. These steps can be repeatedly done.

The purpose of alternatively inflating and deflating the inflatable massaging device is to exert pressure to the user's body part so as to massage it and stimulate pressure points; then let the body part relaxed when it is deflated.

1. An inflatable massaging boots, comprising mainly an air bladder of a general shape of a boots; a housing outside of the air bladder; an air valve provided on the air bladder and the housing; an air pump; a plurality of massage balls; a bottom sheet for positioning the massage balls; and two elastic bands for positioning the bottom sheet; wherein a plurality of welding lines are provided in the air bladder so that two adjacent sheets of the air bladder can be partially welded together, and air cells are formed therein.

2. The inflatable massaging boots as in claim 1, wherein two pairs of cut-off portions art formed on the bottom sheet so as to accommodate the elastic bands and the bottom sheet can be prevented from falling off.

3. The inflatable massaging device as in claim 1, wherein the air pump comprises mainly a housing, a safety valve, a discharge valve, a pumping device, a starting button, and indicating lights.

4. The inflatable massaging device as in claim 3, wherein the safety valve includes a plunger, a piston, a spring, a stopper, a micro-adjustment member, and two bolts.

5. The inflatable massaging device as in claim 3, wherein the discharge valve includes a button, a spring, a socket, a fixation element, a piston, and a bolt.
